(19) United States
(12) Patent Application Publication
(10) Pub. No.: US 2024/0278663 A1
(43) Pub. Date: Aug. 22, 2024

(54) DC VEHICLE CHARGING CIRCUIT COMPRISING A TRANSISTOR AND AN INVERSE DIODE FOR BLOCKING FAULT CURRENT CAUSED BY CHARGING-STATION VARISTORS

(71) Applicant: Vitesco Technologies GmbH, Regensburg (DE)

(72) Inventors: Martin Götzenberger, München (DE); Manuel Brunner, München (DE); Franz Pfeilschifter, München (DE)

(21) Appl. No.: 18/567,518

(22) PCT Filed: Mar. 28, 2022
(86) PCT No.: PCT/EP2022/058117

§ 371 Date: Dec. 6, 2023

(30) Foreign Application Priority Data
Jun. 9, 2021 (DE) 10 2021 205 819.1

(51) Int. Cl. B60L 53/22; B60L 3/04; B60L 53/10; B60L 53/62; B60L 53/66

(52) U.S. Cl. CPC B60L 53/22; B60L 3/04; B60L 53/11; B60L 53/62; B60L 53/66; B60L 2210/14

(57) ABSTRACT

A DC vehicle charging circuit is equipped with an input, a converter circuit designed as a boost converter, and an output. A first input potential of the input is connected to a first output potential of the output via the converter circuit. The converter circuit is connected to a second output potential of the output via a connection point. A second input potential of the input is connected to the connection point without semiconductor switches, except for one transistor. The transistor has an inverse diode, the forward direction of which corresponds to the direction of a charging current that flows when energy is transferred from the input to the output.

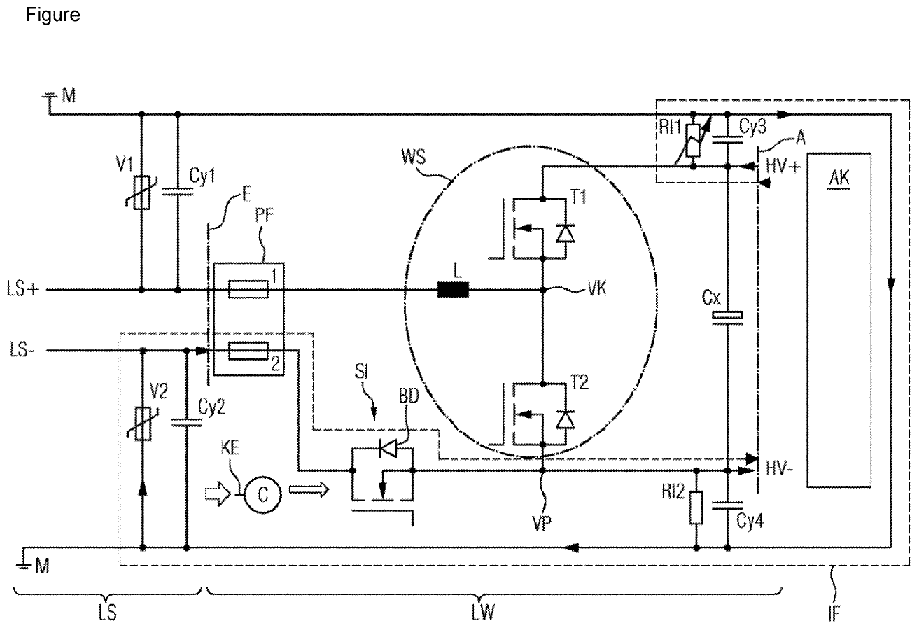

### CROSS REFERENCE TO RELATED APPLICATIONS

This application is the U.S. National Phase Application of PCT International Application No. PCT/EP2022/058117, filed Mar. 28, 2022, which claims priority to German Patent Application No. 10 2021 205 819.1, filed Jun. 9, 2021, the contents of such applications being incorporated by reference herein.

### BACKGROUND OF THE INVENTION

It is known that electric vehicles have an accumulator, which can be charged, for example, via a charging cable from the charging station. In order to achieve high power levels, the accumulator is provided with high nominal voltages, for example, approximately 800 V, while some charging standards define the output voltage of the charging column. There are therefore numerous charging stations which, according to a charging standard, deliver a certain DC charging voltage, for example with a level of 400 V.

The different nominal voltages between the charging station and the accumulator therefore require a voltage conversion. It is also generally known that DC-DC converters are provided for this purpose, which can be accommodated on the vehicle. Since these converters are power converters with power outputs of over 100 kW, their power components are expensive. At the same time, there is a requirement that the charging process should be safe and that, in particular, dangerous contact voltages should not occur.

### SUMMARY OF THE INVENTION

In order to provide cost-effective converters, galvanically non-isolating transformers are used, and an aspect of the invention is to design these to a high safety standard with regard to dangerous contact voltages, despite the use of galvanic coupling.

An aspect of the invention is based on the recognition that the protective measures used by charging stations to prevent overvoltages can cause a situation where an on-board vehicle accumulator with a higher nominal voltage than the charging station can give rise to an unwanted current flow if an insulation fault occurs in an on-board high-voltage potential with respect to ground. It was recognized in particular that the varistors or other voltage-limiting elements, which are installed on the charging station side between a high-voltage potential and a ground potential, can be switched to a conducting state not only if an excessive voltage occurs on them, for example due to a lightning strike, but that this also occurs if a potential of a higher on-board voltage is applied to ground due to an insulation fault.

If, for example, in DC charging stations with an output voltage of 400 V-450 V, a varistor is provided which protects the negative high voltage potential relative to ground with a threshold voltage of, for example, 500 V or 600 V, then this becomes conductive if this high voltage potential to ground exceeds this threshold voltage, for example due to lightning strikes or other faults. However, it has been recognized that the conductive state is also reached if a vehicle with an accumulator or on-board power supply with a nominal voltage of 800 V or 850 V is connected to such a charging station and the positive high-voltage potential of the on-board power supply is applied to the ground potential due to an insulation fault. In this case, the higher accumulator voltage of 800 V will be applied to the aforementioned varistor, so that the threshold voltage of 500 V is exceeded (which is actually intended for a lightning strike), causing an undesired current flow between one of the high-voltage potentials and ground.

Since the differential resistance of the varistor decreases sharply above its threshold voltage, the size of the fault current is limited only by the very low internal resistance of the 800 V accumulator and the resistance of the connection which accidentally causes the insulation fault (i.e. which connects the high-voltage potential of the accumulator/on-board power supply to ground). If the latter connection is also low-resistance, for example if a conductor with high-voltage potential comes into direct contact with a conductor at ground potential, then currents of several hundred amperes can develop, which constitute a serious hazard and, in particular, can also permanently impair the safety function of the varistor.

In order to prevent such a current, which can arise if the high-voltage on-board power supply voltage of the vehicle to be charged is higher than the threshold voltage of the varistor, which is actually intended to protect against lightning strikes, a transistor is used, the inverse diode of which, due to its forward direction, suppresses the corresponding current. The transistor allows a bidirectional connection if the current flow mentioned above is not possible (e.g., if the charging station varistor has a threshold voltage greater than the nominal voltage of the vehicle on-board power supply or if no varistor is provided on the charging station), or allows a connection at which a lower voltage drop occurs than at the inverse diode (in the forward direction). As a safety measure, the transistor allows its inverse diode to suppress the above-mentioned current flow if the threshold voltage of the varistor on the charging station is sufficiently low that, in the event of an insulation fault to ground, the high nominal voltage of the vehicle on-board power supply or of the accumulator on the vehicle switches the transistor to a conducting state. The circuit according to an aspect of the invention enables in particular as small a voltage as possible to be dropped at a connection between a converter circuit of the charging circuit and the input of the charging circuit, wherein in this connection, for example, the transistor or other fuse elements such as a pyrofuse or fusible link can be present to implement fusing functions.

Thus, a DC vehicle charging circuit with an input, a converter circuit and an output is described. The converter circuit is provided between input and output and is designed as a boost converter. The converter circuit is designed to convert a voltage at the input into a higher voltage at the output. The term “boost converter” should therefore be understood in relation to a conversion direction from input to output. Such a converter circuit is used when, for example, an accumulator or a high-voltage on-board power supply is to be connected to the output, the nominal voltage or maximum charging voltage of which is greater than the voltage expected at the input. The voltage to be expected at the input is derived in particular from standards that determine, inter alia, the voltage to be delivered by a charging station. This is, for example, 400 V or 450 V, wherein the converter circuit designed as a boost converter increases this voltage, for example up to a voltage of 600 V, preferably 800 or 850 V or possibly 1000 V.

The input has a first input potential and a second input potential. For example, these are individual contacts or individual connections or busbars. The output also has a first and a second potential. These are referred to as first and second output potentials. A first input potential of the input is connected to a first output potential of the output via the converter circuit. These first two potentials have the same polarity, for example a positive polarity. There is therefore no direct connection between these first potentials, but the converter circuit connects the two potentials to each other.

The converter circuit is also connected to a second output potential. This connection passes through a connection point. This connection point thus has the same potential as the output potential. A second input potential of the input is connected to the connection point. However, this connection is not direct, but leads via a transistor (and not via multiple transistors). Thus, the second input potential is connected to the connection point without the use of semiconductor switches, the only exception being the transistor provided. The second input potential is thus connected to the connection point without the use of semiconductor switches, except for one transistor. There is therefore no further semiconductor switch present between the second input potential and the connection point. This transistor has an inverse diode. The forward direction of the inverse diode is in the direction of a charging current that flows from the input to the output during energy transfer (i.e. the forward direction and the direction of the charging current are the same). The forward direction of the inverse diode is oriented from the output to the input if the transistor which contains the inverse diode is provided between the connection point or the second output potential on the one hand and the second input potential on the other hand, i.e. in particular if the transistor which contains the inverse diode is provided in a negative busbar, which connects the input to the output (i.e. connects the second potentials to each other). The second potentials in this case are the negative potentials of the input and/or output. Since a complementary embodiment is also possible, this specific definition, referring to negative potentials, is only intended to represent one exemplary embodiment and not to limit the subject matter described here to these embodiments, which provide the transistor in the negative potential rail between input and output. The transistor is preferably a MOSFET, these transistors always being formed with inverse diodes (for production reasons), which are also referred to as body diodes.

If a case occurs in which the higher accumulator voltage (on the vehicle side) can cause a varistor on the charging station to switch to the conducting state in the event of an insulation fault, the transistor can be opened, as a result of which its inverse diode suppresses the current flow. If a case occurs in which either no transistor or a transistor with a threshold voltage is provided that cannot be triggered by the (high) accumulator voltage, or in general the on-board voltage, then the transistor can be closed in order to ensure that a lower voltage drop occurs at the transistor during charging than when the transistor is open (and the charging current is routed via the inverse diode as in the former case). The problematic element, namely the varistor on the charging station, which can become conductive at a voltage of the same level as the accumulator voltage, is generally to be understood as an element which begins to conduct at a voltage higher than a threshold voltage. A varistor here is to be understood as any element that does not conduct when a voltage drop across it is below a threshold voltage and conducts when the voltage drop is above the threshold voltage. Since numerous components such as varistor components or spark gaps or semiconductor elements with similar functions are known, all components or circuits that exhibit this behavior will be referred to here collectively as varistors. The term varistor used here is therefore intended to refer to all components or circuits that exhibit the behavior of a varistor component, as generally known in expert circles. The varistor can also be referred to generally as a voltage limiting element.

In particular, contacts of a plug-in charging device, such as a charging socket, are provided as input potentials. These contacts, or the input potentials, are contactable from outside the vehicle by plugging in, in particular directly physically contactable. Between these externally contactable input potentials and the connection point at which the converter circuit is connected to the second output potential, there are, in addition to the said transistor, no further semiconductor switches or semiconductors in general, optionally apart from a safety switch which is connected directly downstream of the second input potential, and which can be configured as an electronic switch.

A further aspect is to drive the transistor in the open state when a varistor (in other words, a voltage limiting element) is provided between a ground potential and one of the input potentials, the threshold voltage of which is below a nominal voltage of the output. Since in this case the nominal voltage of the output, e.g. the nominal voltage of an on-board HV power supply or HV accumulator, is above the breakdown voltage, the transistor must be driven in the open state. (“HV” stands for “high voltage”). The breakdown voltage, i.e. the threshold voltage of the voltage limiting element, is the voltage from which it becomes conductive or conducts and below which the voltage limiting element does not conduct. Driving the transistor in the open state corresponds in particular to holding the transistor in the open state. This driving or holding is monitored by a control device that is connected so as to drive the transistor.

If the nominal voltage of the output (or an operating voltage at the output or a nominal voltage of an accumulator or on-board power supply connected to it) exceeds the threshold voltage of the voltage limiting element, then in the event of an insulation fault it can become conductive and cause the above-mentioned dangerous high current. The state in which all input potentials are connected to a voltage limiting element, the threshold voltage of which exceeds the nominal voltage of the output (or an operating or nominal voltage of a connected accumulator or on-board HV power supply), corresponds to the state in which an unsafe charging station is connected to the input. The voltage limiting element is in particular part of a charging station, so that the voltage limiting element is connected to the input when the charging station is connected to the input. The voltage limiting element connects a ground potential (of the charging station) to an output potential of the charging station, so that when the charging station is connected, the dangerous current flow mentioned can arise when the on-board charging circuit is connected to a device, the operating or nominal voltage of which exceeds the threshold voltage of the voltage limiting element (of the charging station). A control device is provided to control the transistor of the vehicle charging circuit accordingly. The control device may also be configured to detect whether the stated condition is met. Furthermore, a detection device may be provided, which detects whether the condition is met and which in this case outputs a corresponding signal to the control device. This signal indicates whether or not the condition is met. The condition can be determined by measuring or, preferably, by evaluating an IFM which reproduces the charging standard governing the design of the charging station that is connected to the charging circuit. Since the standard also applies to the voltage limiting elements of the charging station, and in particular their design (their threshold voltage), the information provides confirmation of whether the condition is present or not.

Preferably, the control device is configured in a charging state to drive the transistor in the open state (i.e., to hold the transistor open) if it is determined that the condition is met (i.e., if the charging station has a varistor with a threshold voltage lower than the nominal voltage of the output of the converter).

Furthermore, the control device is preferably configured to drive (or hold) the transistor in the closed state in the charging state, if it is determined that the condition is not met. If the transistor is closed in the charging state due to being driven by the control device, this enables the reduction of the power dissipation or heating of the transistor. At the same time, it is ensured that the charging is safe, despite the increased efficiency thus obtained, since the condition has been checked and it has been determined that there is no varistor on the charging station that would conduct if a voltage equal to the battery voltage were applied to it.

If the transistor is closed, the source-drain junction bypasses the inverse diode, wherein this junction switches the transistor to a low-resistance state when the transistor is switched on. As a result, a lower voltage is dropped across the transistor than in a state in which the current flow only passes through the inverse diode (and not through the junction mentioned above). In particular, the control device is configured to activate the transistor as described here in a charging state, that is, when current flows through the transistor to transfer charging power. For example, in a driving state, the transistor can always be driven in an open state, for example to prevent voltages at the charging port while driving, or it can be driven in a closed state when traction power is flowing through the transistor. This is in particular the case if an inverter of an electric drive has switching elements that also form switching elements of the boost converter (in the charging state).

In the following, an embodiment is presented in which the standard of the connected charging station is used to determine whether the condition is met or not. Since the available charging stations are usually designed according to a standard, and this standard also defines whether a voltage limiting element with corresponding threshold voltage must be present in or on the charging station, it can be determined from the charging station standard whether there is a voltage limiting element present that can lead to the above-described problem, by virtue of its threshold voltage being below the nominal voltage of the vehicle charging circuit output. The control device therefore comprises a data input or communication input, which can receive information or a signal that reproduces the charging station standard. By means of such a data or communication input, it is a simple matter to communicate the charging station standard according to which the charging station to be connected or which is connected to the input is designed. The control device may comprise a memory in which charging station identifiers are stored, and associated information about a voltage limiting element of the associated standard. This information can reflect whether or not the standard provides for a corresponding voltage limiting element. In particular, this information can reflect the value of the threshold voltage of the voltage limiting element, or can reflect whether or not the value of the threshold voltage of the voltage limiting element is above a certain threshold. This threshold may in particular be the nominal voltage of the output, or may be reflected by the nominal voltage or maximum voltage of a high-voltage on-board power supply of the vehicle in which the vehicle charging circuit is provided.

The control device is designed in particular to determine whether or not the charging station standard (which was received) provides for one or more voltage limiting elements, the breakdown voltage of which exceeds the nominal voltage of the output. If the threshold voltage does not exceed this nominal voltage, the control device provides the condition as met. If the control device determines that the charging station standard does not provide for a voltage limiting element, or a voltage limiting element with a threshold voltage exceeding the nominal voltage of the output, then the condition is provided as not met. The control device is designed for this purpose. The voltage limiting elements of the charging station mentioned here refer to voltage limiting elements which are provided between a ground or earth potential of the charging station (or a connected supply network) and an output potential (high-voltage potential) of the charging station.

The wording “threshold voltage is below a nominal voltage of the output” can be understood to mean that the threshold voltage amounts to no more than 50 or 80% of the nominal voltage, or no more than 100%, 110% or 120% of the nominal voltage. Further embodiments provide that the wording “threshold voltage exceeds the nominal voltage of the output” corresponds to a threshold voltage which is at least 105%, at least 110%, at least 125% or at least 150% above the nominal voltage of the output. The nominal voltage output in this case is in particular the nominal voltage for which the converter is designed in relation to the output, or can correspond to a voltage that corresponds to the nominal voltage, maximum operating voltage or terminal voltage (current terminal voltage) of an accumulator connected to the output of the vehicle charging circuit. In particular, the nominal voltage can correspond to a nominal voltage, maximum operating voltage or current voltage of a high-voltage on-board power supply connected to the output.

The converter circuit of the vehicle charging circuit is preferably designed to be bidirectional. In this case, the control device is equipped, in particular, not only to transmit power (in the charging state) from the input to the output with voltage conversion, but in a further mode is also designed to control the converter circuit in such a way that it transfers power from the output to the input. In this opposite case, the output serves as an infeed point and the input as a delivery point, for example during recuperation or regenerative feedback. The terms “input” and “output” used here therefore refer to the charging state for the purposes of simplified presentation, but are not meant to exclude the possibility that the converter circuit can also transmit power in the opposite direction (as mentioned above). In general, the input can be referred to as a first connection and the output as a second connection, wherein the converter circuit is designed to transmit power from the first to the second connection, and in a particular embodiment the converter circuit is designed also to transmit energy from the second to the first connection with voltage conversion. As mentioned, the latter is particularly the case with recuperation and regenerative feedback.

If power is transmitted from the output to the input or from the second connection to the first connection, then the control device is preferably designed to provide the transistor in the closed state, in particular to reduce the power dissipation by this transistor. Furthermore, it can be provided that the control device provides for a corresponding energy transfer from the output to the input with voltage conversion only if it has successfully verified that the charging station is designed to absorb power, in particular based on the standard of the charging station.

In specific embodiments the converter circuit comprises a series circuit of two working transistors. These are driven in a clocked mode by the control device during voltage conversion. The connection point of the series circuit of the working transistors is connected to the first input potential via a working inductance of the converter circuit. This connection is either direct (without any additional components, likewise apart from a filter element), or can be protected. In the latter case, the connection point is connected to the first input potential via a working inductance as well as via a fusible link or pyrofuse. In particular, the connection between the connection point and the first input potential is made without semiconductors, in particular without transistors.

The transistor is preferably connected directly to the second input potential via a fusible link or pyrofuse. This connection is also preferably made without using semiconductors, in particular without using transistors. A fuse can be provided both between the connection point and the first input potential and between the transistor and the second input potential. For example, the connection point can be connected to the first input potential via a pyrofuse. Furthermore, the second input potential can be connected to the transistor via a fusible link. This fusible link preferably has a low load limiting integral in order to be able to trip quickly enough, for example a load limiting integral of less than 7,000 A²s. The fuse, if present, is preferably connected between a working inductance of the converter circuit and the first input potential. The working inductance together with the working transistors forms a boost converter (viewed from the input to the output), wherein the fuses mentioned here are preferably provided between this converter, i.e. between the working transistors and the working inductance on the one hand, and the input or the input potentials on the other.

The converter circuit can be housed in a first housing, the transistor being housed in a second housing or in a second module. This second housing or module is interposed between the input and the first housing. This means an existing converter circuit (in the first housing) can be easily upgraded by interposing the transistor or the second housing or module between the first housing and the input. The fuse or fuses mentioned, if present, can preferably also be accommodated in the second housing.

One embodiment provides that the converter circuit has an input filter, which forms the working inductance. Thus, an inductance may be provided between the input and the working transistors, which is formed by an input filter (that is, a filter unit connected downstream of the input), and which acts as a working inductance when the working transistors are switched in a clocked manner. A serial inductance of the filter (provided serially in the connection between input and connection point) then forms the working inductance.

The control device is designed to switch the working transistors on or off alternately, so that together with the working inductance they implement a converter, in particular a boost converter. The duty cycle can be used to adjust the transmission ratio between input and output. In particular, the control device is designed, depending on the voltage provided at the input, to generate a voltage at the output which corresponds as closely as possible to a setpoint voltage. The setpoint voltage can be in particular a setpoint charging voltage of a battery that is connected to the output.

Preferably, the control device is designed to block both working transistors if an insulation fault is detected. A unit for detecting an insulation fault is preferably part of the converter and can be integrated together with the control device in a common unit. The control device is designed in particular to also block the transistor if an insulation fault is detected. Insulation faults here refer to states in which an insulation resistance between a potential of the input or output with respect to a ground potential is below a limit value. An insulation fault can also refer to a state in which the magnitudes of the currents flowing through the input or output potentials differ by more than a limit value.

The DC vehicle charging circuit, and in particular the converter circuit, are high-voltage devices, wherein the prefix “high-voltage” corresponds to a nominal voltage or operating voltage of greater than 60 V, at least 100 V, at least 200 V, at least 400, 600, 800 or 1,000 V. Specific embodiments provide that the output is designed for a nominal voltage or operating voltage of 800, 850 or 900 V. Then, if a charging station is connected to the input, which has a voltage of 400 V and has voltage limiting elements with threshold voltages of 500 V or similar values, then the transistor is driven in an open state.

If no such voltage limiting elements are present, or voltage limiting elements with a threshold voltage of, for example, 1,000 or better 1,200 or 1,500 V, then the transistor can be driven in a closed state. For example, an 800 V charging station would in principle always be classified as safe, since its nominal voltage is not (significantly) below the nominal voltage of the output of the vehicle charging circuit. Thus, such a charging station may also not contain a voltage limiting element, the threshold voltage of which is below the nominal voltage of the output of the vehicle charging circuit. Furthermore, it may be provided that the control device provides a regenerative or recuperation mode if the condition is not met, and that regenerative feedback or recuperation is blocked by the control device if the condition is met. Preferably, during regenerative feedback or recuperation the transistor is driven in a closed state. Recuperation or regenerative feedback is therefore prevented by the control device in the case of unsafe charging stations, i.e. charging stations that meet the condition. In particular, the working transistors are then not driven in a clocked manner such that power transmission from the output to the input (regenerative feedback) would take place.

Finally, a vehicle on-board power supply is described, which comprises a DC vehicle charging circuit as mentioned herein. In addition, the vehicle on-board power supply comprises an externally accessible charging socket, which is designed, for example, according to a standard for plug-in charging. This charging socket is connected to the input. In addition, the on-board power supply comprises a high-voltage accumulator which is connected to the output. In general, instead of an accumulator a high-voltage on-board power supply branch can be connected to the output. This on-board power supply branch can in particular have a high-voltage accumulator. The high-voltage accumulator is in particular a traction accumulator which can be designed as a lithium accumulator.

Finally, a vehicle can be equipped with a corresponding DC vehicle charging circuit, in particular with a high-voltage on-board power supply implemented as mentioned above. An electric drive of the vehicle is supplied by this high-voltage on-board power supply or is part of the high-voltage on-board power supply. The traction inverter is connected to a charging socket of the vehicle via the vehicle charging circuit described here, which can be connected to a charging station. The transistor of the charging circuit, which is thus located between the charging socket and the traction accumulator, is closed only if it has been determined that no voltage limiting element is provided on the charging station, which connects a high-voltage potential of the charging station to a ground potential and the threshold voltage of which is below the nominal voltage or maximum operating voltage of the traction accumulator.

### BRIEF DESCRIPTION OF THE DRAWINGS

The FIGURE is used to explain the embodiments described here.

### DETAILED DESCRIPTION OF THE PREFERRED EMBODIMENTS

The FIGURE shows a charging station LS and a DC vehicle charging circuit LW connected thereto, which in turn is connected to an accumulator AK. The charging station has two high-voltage potentials LS+, LS− and a ground potential. Each high-voltage potential LS+, LS− is connected to the ground potential via a separate varistor V1, V2. Furthermore, there are charging station capacitances Cy1, Cy2, which represent the capacitance between the ground potential and the high-voltage potentials LS+, LS− of the charging station LS. The charging station LS is connected to the vehicle charging circuit LW via an input E of the vehicle charging circuit LW.

The vehicle charging circuit LW thus comprises this input E, which is followed by optional fuses 1, 2 (=all-pole safety circuit PF). These are used to connect the individual input potentials of the input E (which correspond to the potentials LS+, LS− of the charging station LS) to the converter circuit WS. Here, the first input potential LS+ is connected via a working inductance L to working transistors T1, T2 of the converter circuit WS. The second input potential LS− is connected to a connection point VP via a transistor SI. At this connection point VP, the converter circuit WS is connected to a potential HV− of an output A of the charging circuit LW. The connection point VP is thus connected via the transistor SI to input E, in particular to the second input potential LS−.

The converter WS provides the two working transistors T1, T2 in a series circuit, so that the working inductance L is connected to the connection point VK between the two transistors T1, T2 (which in turn leads to the first input potential LS+). Furthermore, a DC link capacitor Cx, which according to other embodiments can also be assigned to the converter circuit WS, is connected downstream of the converter circuit WS. Capacitors Cy3, 4 are also present on the DC vehicle charging circuit side, which connect the two output potentials HV+, HV− of the output A to the ground potential M. It should be noted here that the charging circuit LS is connected to the DC vehicle charging circuit LW not only via the two high-voltage potentials LS+, LS−, but also via an earthing connection. In the illustrated application, the vehicle charging circuit LW is connected to an accumulator AK, which is connected to the charging circuit LW in particular via the connection A, and thus via the two output potentials HV+, HV−. In the Figure, it is assumed that the accumulator AK is a high-voltage accumulator with very low internal resistance and can deliver very high short-circuit currents in the event of a short circuit.

If there is an insulation fault RI1, which represents an excessively low insulation resistance between the output potential HV+ (first output potential) and the ground potential M, then the high-voltage potential HV+ of the accumulator AK or the output A is transmitted to ground via this excessively low insulation resistance RI1. This transmission direction is illustrated by the dashed line which starts at HV+, passes through the excessively low insulation resistance RI1 (equivalent to an insulation fault), and passes to the ground potential M, in particular of the charging station LS. If a varistor or other voltage-limited element V2 is present there, which is designed according to the output voltage of the charging station LS, then this begins to conduct. This problem arises whenever a voltage is provided at the output A or at the accumulator AK that exceeds the threshold voltage of the varistor V2, which is the case, for example, if the charging station LS is designed for an output voltage of 400 or 450 V, the varistor V2 has a threshold voltage for overvoltage limiting of, for example, 500 V (greater than the nominal voltage or maximum operating voltage of the charging station LS), but which is lower than the voltage at the output A, which can be 800 or 850 V for an 800 V accumulator. RI2 represents an error-free insulation resistance between the output potential HV− (second output potential) and the ground potential M.

In this case, the varistor V2 is switched to the conducting state, in which the current is then fed via the input E or via the second input potential LS− into a negative current path of the charging circuit, which leads to the accumulator or output A. In this case, the current then continues to flow from the conducting varistor V2 via the input (second input potential LS−) and on to output A, in particular to its second output potential. This would be the case if transistor SI were not present. Very high currents would occur, and at least the fuse element 2 would trip. Furthermore, the varistor V2 would be damaged due to the high short-circuit current of the accumulator AK, so that the charging station would then no longer be protected during future charging operations. The current path that results through RI1 and passes through varistor V2 is shown in dashed lines.

It is therefore proposed to provide a transistor SI as shown between the second input potential LS− of input E and the second output potential HV− (or the converter circuit WS). In other words, there is then a transistor between the connection point VP (within a negative busbar of the charging circuit LW). Further embodiments provide that the transistor SI is not provided between the connection point VP or the converter WS and the input, but between the connection point VP and the output A or the second output potential HV−. A control device C is provided, which is connected so as to drive the transistor. The controller determines whether or not there is a voltage-limited element at the input E with a threshold voltage below the maximum operating voltage or nominal voltage of the output or the accumulator. If this is the case, that is, if a current can flow, as shown with the dashed line, then the control device C opens the transistor SI. In this case, the inverse diode or body diode BD of the transistor SI blocks, in particular because the current direction would be opposite to the current direction that would occur in charging mode and because the blocking direction of the inverse diode is opposite to the current direction that would occur during charging. The transistor SI is preferably embodied as a MOSFET. Since the current direction (during charging) is the same as the current direction that would result in normal charging operation, the charging operation is not in principle dependent on the switching position of the transistor SI (since the inverse diode conducts in this current direction). However, the transistor SI is preferably closed during charging and if it is determined that there is no voltage element with too low a threshold voltage at the input E. This reduces the voltage drop across the transistor SI during charging.

The control device C preferably comprises a communication input KE, via which a signal can be received or information can be fed in, which reflects whether or not a voltage limiting element with a threshold voltage below the maximum voltage of the output or accumulator AK is present at input E (on the charging station). The signal or information may directly contain a statement about this condition, or may indirectly reflect this information.

Preferably, the control device C is designed to receive an identifier via the communication input KE, which specifies the standard according to which the connected charging station LS is designed. Based on this information, the control device C can be designed to determine whether or not a voltage limiting element with a threshold voltage lower than the nominal voltage of the output A is present. To do so, the control device C may have a lookup table, for example, that assigns an entry to various standards or identifiers that define the standard, which entry reflects the threshold voltage of the varistor or reflects whether or not a varistor with an associated threshold voltage is present. If, according to this entry, there is no voltage-limited element present, or a voltage-limited element is provided that has a threshold voltage greater than the nominal voltage at the output A or the accumulator AK (e.g. is at least 105%, 110%, 120%, 150% or 200% of that value), then this can be considered a “safe” charging station, and the control device C can close the transistor SI. If this is not the case, and the entry indicates that the charging station includes a voltage-limited element with an associated threshold voltage, then the control device C is configured to open the transistor SI so that its inverse diode BD blocks if an insulation fault such as the insulation fault RI1 occurs. Before the control device C has determined whether or not the condition is met, it preferably switches the transistor SI to the open state.

The control device C can also be connected so as to activate the working transistors T1, T2 and to activate them as mentioned in order thus to provide a boost converter WS together with the working inductance L. In addition, the control device can be configured to activate the working transistors T1, T2 in such a way that they convert a voltage at input E into a voltage at output A (step-up conversion), or, optionally, a voltage at output A into a voltage at input E, for example for regenerative feedback. In the latter case, the converter operates as a step-down converter.

1. A DC vehicle charging circuit having an input converter circuit in the form of a boost converter, and an output, wherein a first input potential of the input is connected to a first output potential of the output via the converter circuit, and the converter circuit is connected to a second output potential of the output via a connection point, wherein a second input potential of the input is connected to the connection point without any semiconductor switches, apart from a transistor, and wherein the transistor has an inverse diode, the forward direction of which points in the direction of the charging current that flows in the HV-minus path when energy is transferred from the input to the output.

2. The DC vehicle charging circuit as claimed in claim 1, further comprising a control device which is configured to determine whether the condition is met that at the input a voltage limiting element is connected between one of the input potentials and a ground potential, the threshold voltage of which is below a nominal voltage of the output, and wherein the control device is connected so as to drive the transistor and is configured to hold the transistor in the open state if it is determined that the condition is met.

3. The DC vehicle charging circuit as claimed in claim 2, wherein the control device is configured in a charging state to keep the transistor in the open state if it is determined that the condition is met, and is configured in the charging state to control the transistor in the closed state if it is determined that the condition is not met.

4. The DC vehicle charging circuit as claimed in claim 2, wherein the control device has a communication input, which is configured to receive a signal that reproduces a charging station standard, and the control device is configured to determine whether the charging station standard provides voltage limiting elements, the threshold voltage of which is above the nominal voltage of the output or does not exceed this nominal voltage, wherein in the latter case the control device provides the condition as being met.

5. The DC vehicle charging circuit as claimed in claim 1, wherein the converter circuit is designed bidirectionally.

6. The DC vehicle charging circuit as claimed in claim 1, wherein the converter circuit has a series circuit of two working transistors, the connecting node of which is connected to the first input potential via a working inductance of the converter circuit, either directly or via a fusible link or pyrofuse.

7. The DC vehicle charging circuit as claimed in claim 1, wherein the transistor is connected to the second input potential directly or via a fusible link or pyrofuse.

8. The DC vehicle charging circuit as claimed in claim 1, wherein the converter circuit is accommodated in a first housing, and the transistor is accommodated in a second housing which is interposed between the input and the first housing.

9. The DC vehicle charging circuit as claimed in claim 6, wherein the working inductance, via which the converter circuit is connected to the input, is provided by a serial inductance of an inductive input filter which is connected downstream of the input.
